(19) United States
(12) Patent Application Publication
(10) Pub. No.: US 2012/0137025 A1
(43) Pub. Date: May 31, 2012

(54) Communication Bus with Shared Pin Set

(76) Inventors: David Ross Evoy, Chandler, AZ (US); James Raymond Spehar, Chandler, AZ (US)

(21) Appl. No.: 12/955,641

(22) Filed: Nov. 29, 2010

(51) Int. Cl. G06F 3/00

(52) U.S. Cl. 710/11

(57) ABSTRACT

Bus communications are effected. In accordance with one or more example embodiments, a bus circuit is configured for communicating data in accordance with a main protocol (e.g., as a default), and for communicating with an alternate protocol when signals corresponding to the main protocol are not present. In some implementations, a sense circuit is used with input pins to sense a type of signal for bus communications, and to control communications on the bus with a protocol appropriate for the sensed signals, and for a main protocol when main protocol signals are sensed (e.g., for a default bus operation, or for test operation).

The present invention relates generally to data communications, and more specifically, to communications busses configured for operating with shared pin sets.

Communication busses such as open drain busses, which may include an Inter-Integrated Circuit bus, a System Management Bus (SMBus) and others, include a data line and a clock line, with pins used for operating, or driving, the bus. The Inter-Integrated Circuit bus is often referred to as an IIC, I2C or I²C bus, and is hereinafter referred to as an I2C bus. The data line and the clock line can each be referred to individually as a bus line, or simply as a line. In many implementations, each of the bus lines is connected to a pull-up resistor, interface devices and a capacitance representing distributed capacitance of the bus line and the total input capacitance of the connected interface devices.

Busses are used in a variety of implementations, including those involving servers and computers. Generally, the pins used for controlling/driving the bus control communications in accordance with whatever protocol the bus is configured to operate upon, such as protocols in accordance with the operation of the I2C bus. These pins are thus dedicated to their use in this context.

The implementation of various disparate devices with busses such as I2C busses has been challenging, relative to the available pin sets for use with these devices.

The present invention is exemplified in a number of implementations and applications, some of which are summarized below.

In accordance with an example embodiment, a bus communications circuit includes a set of input pins connected to the bus, a configurable protocol sense circuit and an override sense circuit. The configurable protocol sense circuit is responsive to receiving an alternate protocol signal on the input pins by configuring the bus for communicating data in accordance with a protocol for the alternate protocol signal. The override sense circuit is coupled to the input pins and is responsive to at least one of sensing a main protocol signal on the input pins and sensing a main protocol communication on the bus, by overriding a configuration set via the configurable protocol sense circuit and configuring the bus for communicating data in accordance with the main protocol signal.

Another example embodiment is directed to a communication system for operating in accordance with a main protocol and a plurality of alternate protocols. The system includes a bus, a pair of multilevel input pins and a control circuit connected to the input pins. The control circuit is responsive to sensing a main protocol signal by controlling signals passed on the bus using the main protocol. In the absence of sensed main protocol signals, the control circuit is responsive to receiving an alternate protocol signal on the input pins in accordance with one of a plurality of alternate protocols, by controlling signals passed on the bus in accordance with a protocol for the alternate protocol signal and an input device operating with the alternate protocol.

Another embodiment is directed to a method for controlling communications on a bus circuit. In a configurable protocol sense circuit, and in response to receiving an alternate protocol signal on a set of input pins connected to the bus circuit, the bus is configured for communicating data in accordance with a protocol for the alternate protocol signal. In an override sense circuit coupled to the input pins, and in response to at least one of sensing a main protocol signal on the input pins and sensing a main protocol communication on the bus, a configuration set via the configurable protocol sense circuit is overridden, and the bus circuit is configured for communicating data in accordance with the main protocol signal.

The above summary is not intended to describe each embodiment or every implementation of the present disclosure. The figures and detailed description that follow more particularly exemplify various embodiments.

The invention may be more completely understood in consideration of the following detailed description of various embodiments of the invention in connection with the accompanying drawings, in which:

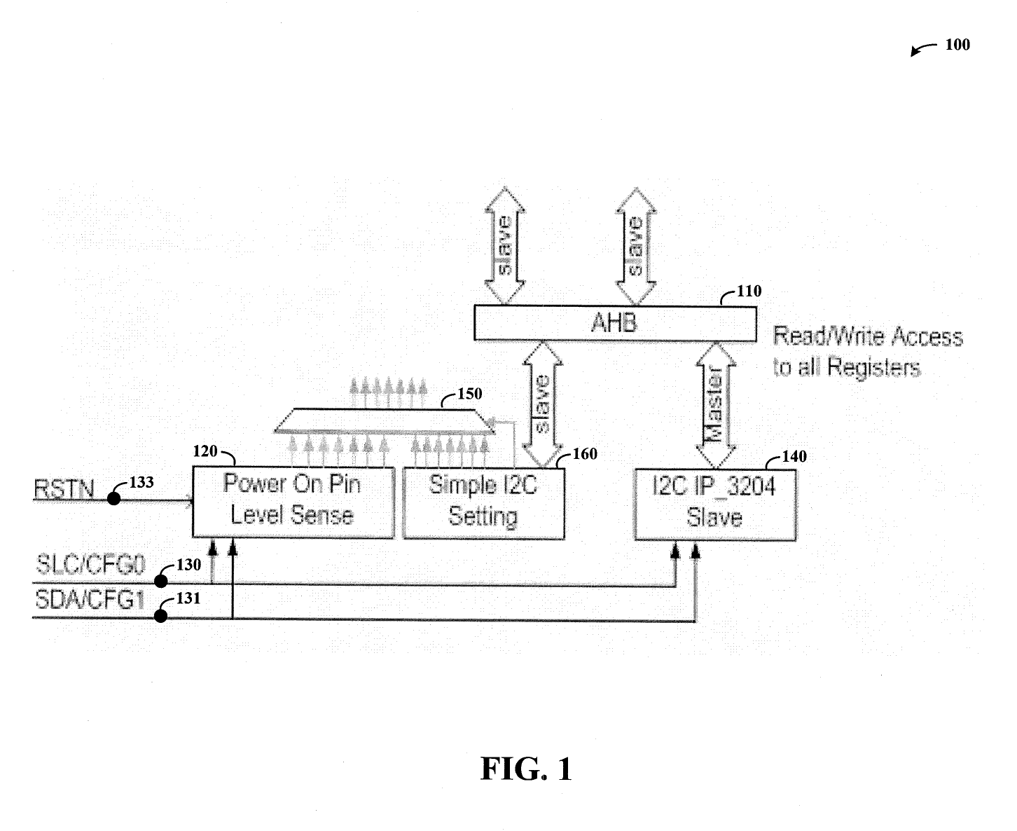

FIG. 1 shows a communications circuit for shared pin set operation with a data bus using multiple protocols, according to an example embodiment of the present invention;

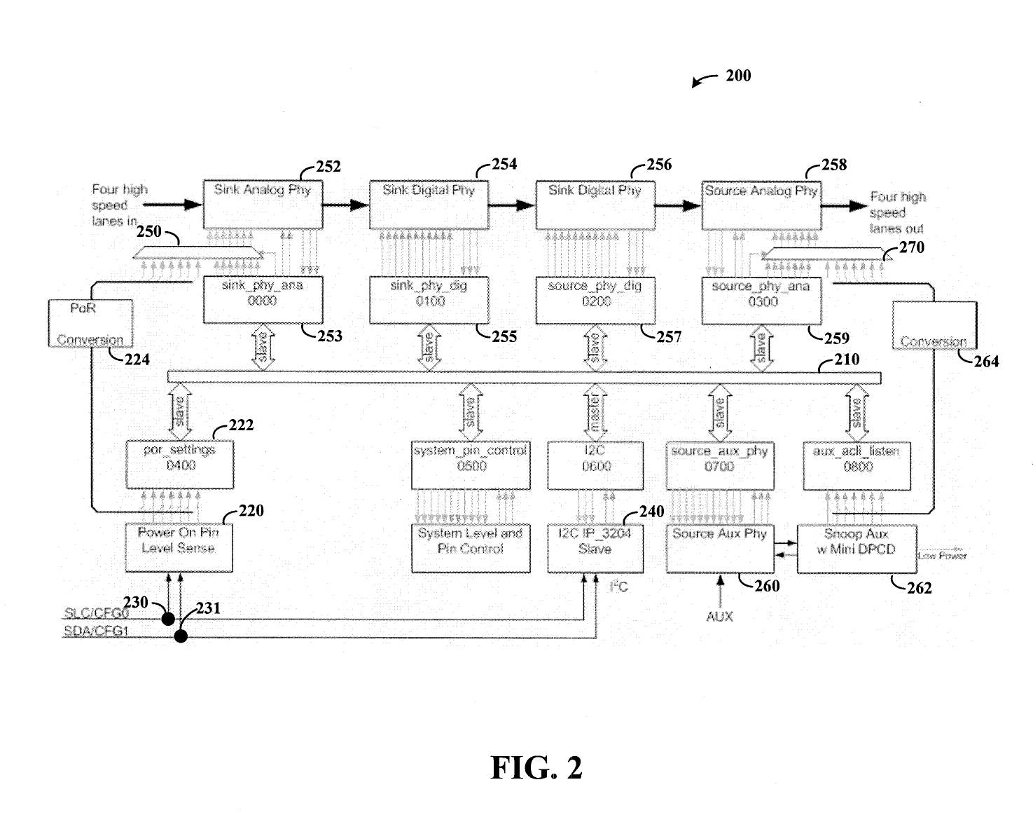

FIG. 2 shows a communications circuit for shared pin set operation, in accordance with another example embodiment of the present invention;

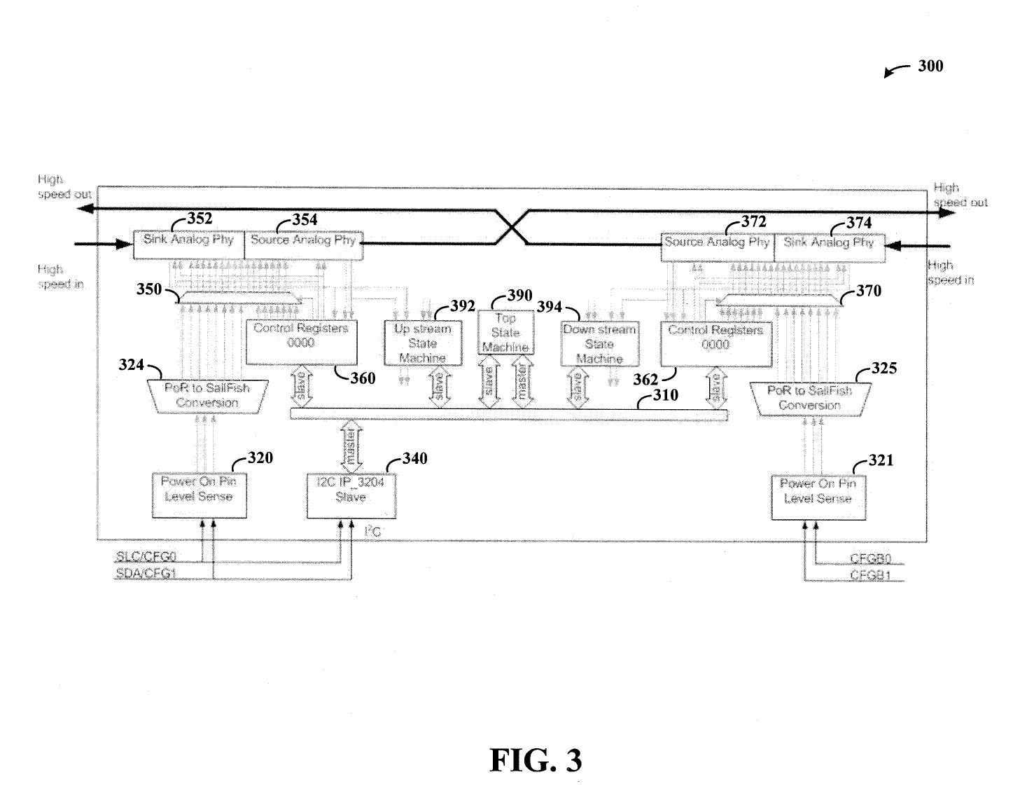

FIG. 3 shows a communications circuit for shared pin set operation, in accordance with another example embodiment of the present invention; and

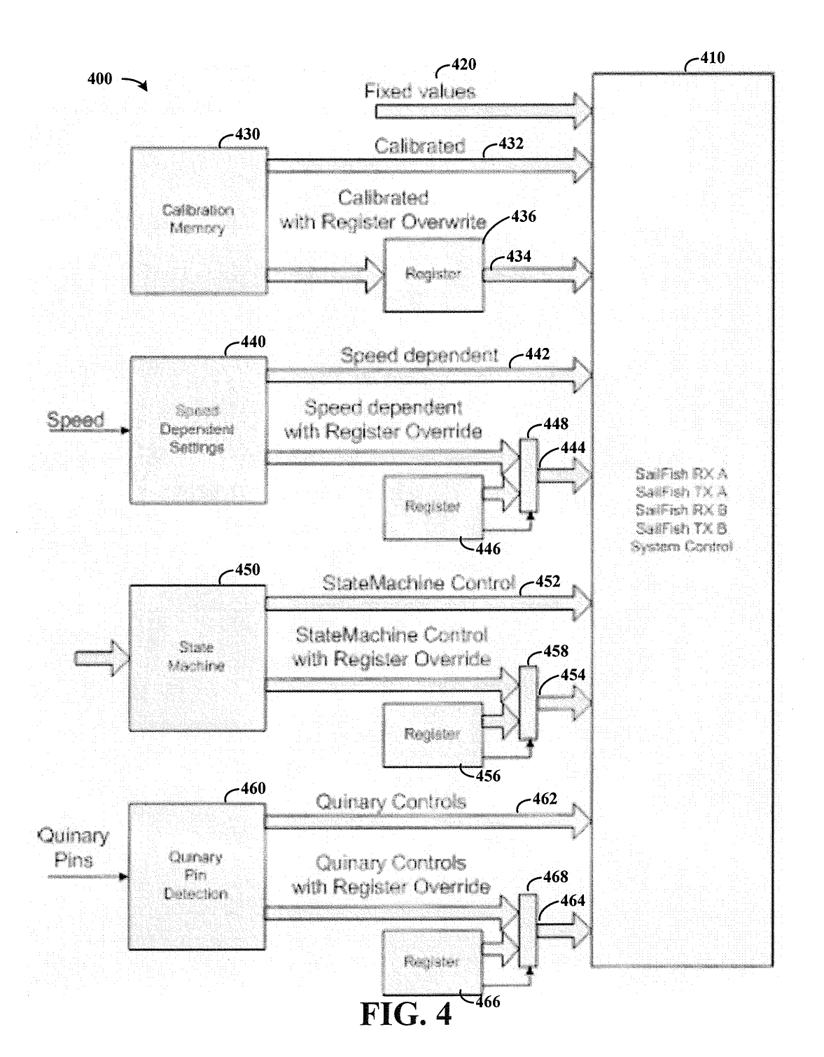

FIG. 4 shows a block diagram of a system for controlling communications on a bus, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined by the claims.

The present invention is believed to be applicable to a variety of different types of processes, devices and arrangements for use with communications busses. While the present invention is not necessarily so limited, various aspects of the invention may be appreciated through a discussion of examples using this context.

According to an example embodiment of the present invention, bus communications are controlled to effect a main, or master type of protocol, as well as one or more alternate protocols. In some implementations, a communications circuit is configured to operate using the main protocol as a default-type condition, such as when signals corresponding to the main protocol are sensed or otherwise passed on a bus. When signals corresponding to the main protocol are not sensed/passed, and in response to an alternate protocol, the communications circuit is configured or otherwise operated to pass data corresponding to the alternate protocol.

A more particular example embodiment is directed to controlling communications using a configurable protocol sense circuit and an override sense circuit. In response to receiving an alternate protocol signal on a set of input pins connected to the bus circuit, the bus is configured for communicating data in accordance with a protocol for the alternate protocol signal. In response to sensing a main protocol signal on input pins and/or on the bus, any previously-set bus communication configuration is overridden, and the bus circuit is configured for communicating data in accordance with the main protocol signal. These approaches may, for example, involve setting or using one or more registers having data that is used to control communications on the bus, storing data in such a register, or overriding communications set via one or more registers.

This approach may be carried out using, for example, a pair of sense pins and circuit components that can be used to carry out one or more types of bus protocol control, and may involve a common circuit that effects both configuration and override functions. For example, some embodiments are directed to a sense circuit that senses both main and alternate protocols and configures a bus circuit for operating in response to the sensed protocol. This configuration may involve separate circuit components as well, such as a configurable sense circuit and an override circuit respectively operated for configuring alternate protocol operation or overriding to use a main protocol. For instance, register circuits can be configured with data for operating a main protocol, or with data for operating an alternate protocol, with the respective information being selectively used for one of the register circuits having data for the particular protocol being used. In some implementations, registers having a configuration are reconfigured with data for a current (e.g., main or alternate) protocol. Alternately, direct control data can be provided by a control circuit, without using such registers.

A more particular example embodiment is directed to a communication system that operates in accordance with a main protocol and one or more of a plurality of alternate protocols. The system includes a bus, a pair of multilevel input pins and a control circuit connected to the input pins. The control circuit may include, for example, a sense circuit that senses an input signal and/or signals on a bus, and a controller that controls the application of a particular protocol (e.g., using a multiplexing circuit).

In some implementations, the control circuit is responsive to sensing a main protocol signal by controlling signals passed on a bus using the main protocol. In the absence of sensed main protocol signals, the control circuit is responsive to receiving an alternate protocol signal on the input pins (for one of the alternate protocols) by controlling signals passed on the bus in accordance with the alternate protocol. Other embodiments are directed to external control, with protocol configuration effected via an external input (e.g., for testing or other control).

In accordance with a more particular example embodiment, two multi-level pins are overlapped with an I2C bus circuit. A controller configures the pins based upon the connectivity of an I2C signal, to pass signals in accordance with the I2C protocols when such signals are present, and to pass signals according to one or more other protocols in the absence of an I2C signal. In this context, the same pins can be used for multiple applications, with a default application being for use with the I2C bus circuit.

When an I2C signal is not connected to the pins, the pins can provide multiple settings. For example, if quinary pins are used, the two 5 level pins that are part of a quinary pin set can be configured for operation in accordance with 25 modes of operation/tuning.

Turning now to the figures, FIG. 1 shows a communication circuit 100 configured for shared pin set operation with a data bus 110 using multiple protocols, according to another example embodiment. A power on pin level sense block 120 is selected as the source of the internal mode signals for the communication circuit 100 at power on. The outputs of the power on pin level sense block 120 are dependent on the level on SLC/CFG0 and SDA/CFG1 pins 130 and 131, and are provided to a multiplexer circuit 150 for setting the configuration of the data bus 110.

The power on pin level sense block 120 senses the input on pins 130 and 131, and uses the sensed inputs to drive the internal mode control signals at power on. In some implementations, the input on pins 130 and 131 sensed by the power on pin level sense block 120 is latched at the end of a reset time, and de-asserted when the reset input at 133 is RSTN=1.

An I2C block 140 is configured to set the operation of the communication circuit 100 to an I2C protocol, with its output also provided to the multiplexer circuit 150. In some implementations, the I2C bock 140 sits idle until it sees a valid I2C start signal, such as a predefined start signal for I2C communication. In other implementations, the I2C block 140 sits idle until it sees a valid I2C transaction on the bus 110. The I2C block 140 is also configured to alter registers internal to the device and used in controlling communications in accordance with protocols, as may be carried out using I2C-based protocols/standards as discussed herein. Accordingly, using I2C transactions, the host system including the I2C block 140 can take control of the internal mode of the circuit 100 and override the power on pin level sense signals at block 120, controlling the device's mode (e.g., with I2C settings as in block 160). In some implementations, all of the registers internal to the device are mapped into the I2C space. With an I2C protocol set, an I2C controller 160 can control operation of the bus 110 accordingly.

The communication circuit 100 is implemented using one or more of a variety of configurations, in accordance with various embodiments. In one implementation, the simple I2C settings and the power on pin level sense are identical, and in another implementation, the simple I2C settings are configured to provide additional granularity.

Access from the I2C block can be controlled using a variety of approaches. In some implementations, access from the I2C block is very limited. In other implementations, access from the I2C block involves all registers, status, and control bits in the I2C space, such as in the examples described below.

As consistent with the above discussion, the communication circuit 100 is responsive to a code-type of trigger value by self-configuring for operation in accordance with the I2C protocol. Accordingly, when an appropriate trigger value is received, the circuit 100 self-configures appropriately for processing signals in accordance with the I2C bus structure and related protocols. If such a trigger is not received, the communication circuit 100 can operate in accordance with other configurations. Similarly, pre-defined configurations can be effected in the circuit 100 using other code-types of values, such as for a particular type of circuit using the pins.

In these contexts, different code-type values can be used to set, or configure, the circuit for use with different sets of registers and related information for effecting an appropriate protocol. Such registers may, for example, be implemented for full or limited customer access, where a customer in this context relates to an end user of the communication circuit 100, where the circuit is configured at the factory to operate based on code-type values.

In some implementations, the circuit 100 is also configured to filter input signals. This filtering may be effected, for example, to ensure that analog inputs are not communicated as a real I2C transaction, or to ensure that signals that are not appropriate for another pin set configuration are not inadvertently passed. This approach can be carried out using, for example, a digital filter, with the circuit configured with an unlock protocol that serves to ensure that inadvertent changes do not happen (without the unlock protocol being carried out, changes are not permitted).

According to another embodiment, and as may be implemented with the circuit 100, one or more internal registers are configured with data for use in carrying out testing protocols. This approach may involve, for example, an I2C bus circuit with internal registers that provide extended configuration capabilities, based upon settings of the registers in accordance with a particular testing protocol, such as may be implemented using automatic, or automated, test equipment (ATE).

In a more particular example embodiment, the circuit 100 is implemented using an I2C and quinary pin type approach as follows, to configure the circuit for operation with two or more types of devices involving the processing of audio-visual data for applications such as television, computing and others. One such type of device is a DisplayPort type of receiver available from STMicroelectronics, of Geneva, Switzerland, which is configurable using an I2C host interface. Such configuration may, for example, be carried out in accordance with the GM68020H data brief; available from STMicroelectronics, which is fully incorporated herein by reference.

For such receivers with a single loop training configuration, an auxiliary channel can be monitored, or snooped, to gather information. This information can be used for configuring a downstream port. An upstream port can also be configured using configuration parameters, such as described herein, to set the operation of the interface for a particular implementation. In this context, many embodiments are directed to the application of a configurable protocol as discussed herein to carry out such operation in a media-type (e.g., audio-video) circuit.

FIG. 2 shows a circuit 200 for a relatively high end solution for operating a communication circuit, in accordance with another example embodiment. The approach shown in FIG. 2 may, for example, be implemented without a microprocessor, using a plurality of registers as shown (or otherwise) that may be read and written via a configurable bus communication circuit (e.g., an I2C bus circuit) as discussed herein. In addition, the approach shown in FIG. 2 may be implemented with a variety of different types of systems, with one such system being the SailFish hardware platform available from Equator of Campbell, Calif.

As with the circuit shown in FIG. 1, a power-on pin level sense block 220 is configured to sense inputs at 230 and 231, and to provide a corresponding output to set the configuration of the circuit 200 accordingly, for operation with I2C protocols (via block 240) or otherwise as configured. An output of the power-on pin-level sense block 220 is used to set POR settings at 222, and also provided to multiplexer 250 via a conversion block 224, which is tailored to the particular application (e.g., SailFish as discussed above).

The power on values of all the registers are selected to suit the application of the respective registers. Quinary pins at 250 set sink analog phy options at block 252 at power on, which can be set to a default protocol (e.g., SailFish as discussed above) on power-on. Additional blocks 254 and 256 (Sink Digital Phy) and source analog phy are connected as shown, to receive and pass four high speed lanes coming in at block 252 and out at block 258. Corresponding registers 253, 255, 257 and 259 are connected to blocks 252, 254, 256 and 258.

When an I2C signal is sensed at block 240, I2C settings overtake all the sink_phy_ana registers, changing the POR values and taking over control of the settings from the power on pin level sense block 220.

In some implementations, settings are set using an input on an auxiliary (AUX) block 260, which can be used to effect external control. In some implementations, a snoop function is used at block 262 in a manner similar to that discussed above. I2C settings can be used to view the snooped values, and also to override registers such as DPCD registers, via conversion block 264 and multiplexer 270. This approach can be used to set downstream control, via configuration of the source_analog_phy 259. This fully automates the control of the downstream link, and also allows for external control and visibility.

FIG. 3 shows a bus circuit 300, with dual sensing, according to another example embodiment. The circuit 300 may, for example, be used in a SATA (serial advanced technology attachment) device that uses an overlapping I2C-type configuration along with the Quinary or similar analog pin sensing.

The circuit 300 includes dual power-on pin-level sense blocks 320 and 321, which respectively sense different input pins. As similar to the approaches discussed above, an I2C block 340 also senses the inputs that sense block 320 senses, and overrides control of a bus 310. Signals at each of the sense blocks are converted at 324 and 325, respectively, and passed to demultiplexers 350 and 370 to set control registers 360 and 362. Each side has sink and source analog Phy blocks 352/354, and 374/372. Top, upstream and downstream state machines (390, 393 and 394) are also connected as shown, for controlling one or more operations such as those for implementing a particular protocol or a testing protocol such as specified by the Joint Test Access Group (JTAG). Such control can be set via an external input as described in connection with FIG. 2. Accordingly, different control can be effected for each pair of input pins, based upon sensing at each pin and the respective control as effected via demultiplexers 350 and 370, for upstream and downstream communications.

FIG. 4 shows a block diagram of a system 400 showing several exemplary inputs and controls for controlling communications on a bus, according to other example embodiments of the present invention. Different types of controls are implemented, using different manners of setting such controls, to suit different applications. In some implementations, fixed values are used as provided at 420, such as for inputs that may be tied high or low.

Other implementations are directed to using calibration memory 430 to directly set configuration options, such as via calibrated input 432 or calibrated input 434 by effecting a register overwrite at 436. In some implementations, the non-volatile memory is programmed with configuration operations for the SailFish IP protocol as discussed above. Such calibration memory can also be used to set the POR value of registers that can be altered after boot. These registers can be used for debug functions, and to enable the use of parts that are not yet calibrated.

Another implementation is directed to a speed-dependent control as carried out at block 440. These controls can be made directly at 442, or indirectly by overriding register 446 at 448. One such approach involves using SailFish (discussed above) controls that are speed dependent, and/or controls driven based on a currently detected speed. In some implementations, a speed dependent value applied has register(s) that can override automatically selected values.

In other implementations, a state machine 450 is used, to provide direct control at 452 or indirectly at 454, by overriding register 456 at 458. For example, overrides can be used for test and debug functions, and can be effected under conditions in which the state machine 450 operates autonomously.

In other implementations, quinary pins 460 (and/or other pin control) are used to provide direct control at 462 or indirectly at 464, by overriding register 466 at 468. For example, overrides can be used for registers most likely to be used by customers (and/or in applications) for which a main bus control protocol such as the I2C is also used.

A variety of other configurations can be implemented, similar to the examples shown in and described above in connection with FIG. 4. For example, one implementation is directed to speed dependent times used in calibration memory, with speed-dependent settings being retrieved from calibration memory. Another approach involves setting power on resets for registers that can be set, using a similar approach.

Based upon the above discussion and illustrations, those skilled in the art will readily recognize that various modifications and changes may be made to the present invention without strictly following the exemplary embodiments and applications illustrated and described herein. For example, a variety of different types of registers, communication protocols and data can be communicated using one or more approaches as discussed herein. Such modifications do not depart from the true spirit and scope of the present invention, including that set forth in the following claims.

1. A bus communication circuit comprising:
a set of input pins connected to the bus;
a configurable protocol sense circuit configured to, in response to receiving an alternate protocol signal on the input pins, configure the bus for communicating data in accordance with a protocol for the alternate protocol signal; and
an override sense circuit coupled to the input pins and configured to, in response to at least one of sensing a main protocol signal on the input pins and sensing a main protocol communication on the bus, override any configuration via the configurable protocol sense circuit and configure the bus for communicating data in accordance with the main protocol signal.

2. The circuit of claim 1,
further including a register that stores data used for controlling communications on the bus, and
wherein the configurable protocol sense circuit is configured to, in response to receiving an alternate protocol signal on the input pins, configure the bus for communicating data in accordance with a protocol for the alternate protocol signal by setting data in the registers to configure the bus.

3. The circuit of claim 1, wherein the configurable protocol sense circuit is configured to, in response to receiving an alternate protocol signal on the input pins, configure the bus by directly passing control data for controlling the operation of the bus.

4. The circuit of claim 1,
further including a register that stores data used for controlling communications on the bus with the main protocol, and
wherein the configurable protocol sense circuit is configured to, in response to receiving an alternate protocol signal on the input pins, configure the bus for communicating data in accordance with a protocol for the alternate protocol signal by overriding the communications control in the bus set by the register.

5. The circuit of claim 1,
further including a register that stores data used for controlling communications on the bus with the main protocol, and
wherein the configurable protocol sense circuit is configured to, in response to receiving an alternate protocol signal on the input pins, configure the bus for communicating data in accordance with a protocol for the alternate protocol signal by overwriting data in the register with protocol data for the alternate protocol to control communications on the bus.

6. The circuit of claim 1,
further including a register that stores data used for controlling communications on the bus,
wherein the configurable protocol sense circuit is configured to, in response to receiving an alternate protocol signal on the input pins, configure the bus for communicating data in accordance with a protocol for the alternate protocol signal by writing alternate protocol data to the register to control communications on the bus with the protocol for the alternate protocol signal, and
the override sense circuit is configured to, in response to at least one of sensing a main protocol signal on the input pins and sensing a main protocol communication on the bus, override any configuration via the configurable protocol sense circuit and configure the bus for communicating data in accordance with the main protocol signal by writing main protocol data to the register to control communications on the bus with the main protocol.

7. A communication system for operating in accordance with a main protocol and a plurality of alternate protocols, the system comprising:
a bus;
a pair of multilevel input pins;
a control circuit connected to the input pins and configured to control communications on the bus by,
in response to sensing a main protocol signal, control signals passed on the bus using the main protocol, and
in the absence of sensed main protocol signals, and in response to receiving an alternate protocol signal on the input pins in accordance with one of the plurality of alternate protocols, control signals passed on the bus in accordance with a protocol for the alternate protocol signal and an input device operating with the alternate protocol.

8. The system of claim 7, wherein the control circuit is configured to override a bus communications configuration for an alternate communications protocol in response to sensing a main protocol signal, by reconfiguring registers used for controlling communications on the bus.

9. The system of claim 7, further including an external input port configured to receive protocol configuration inputs, wherein the control circuit is configured to control signals passed on the bus using a protocol specified by a protocol configuration input received on the external input port.

10. The system of claim 7, wherein the control circuit is configured to, in response to receiving a test input signal corresponding to a joint test access group (JTAG) protocol, control signals passed on the bus using the main protocol.

11. The system of claim 7, wherein the control circuit is configured to control signals passed on the bus using the main protocol in response to sensing a main protocol signal that corresponds to a predefined trigger value for indicating operation using the main protocol signal.

12. The system of claim 7,
further including a register configured to store data corresponding to a communications protocol for the bus, and
wherein the control circuit is configured to control signals passed on the bus by accessing and using the stored data in the register to control signals passed on the bus, based upon the sensed protocol signals.

13. The system of claim 7,
further including a register configured to store data corresponding to a communications protocol for the bus, and
wherein the control circuit is configured to control signals passed on the bus by, in the absence of sensing the main protocol signal, accessing and using the stored data in the register corresponding to the alternate protocol to control signals passed on the bus.

14. The system of claim 7,
further including a register configured to store data corresponding to a communications protocol for the bus, and
wherein the control circuit is configured to control signals passed on the bus by, in response to sensing the main protocol signal, accessing and using the stored data in the register corresponding to the main protocol to control signals passed on the bus.

15. The system of claim 7, wherein
the communications system includes at least two pairs of multilevel input pins, each pair being connected to sense data for a particular data stream, and
the control circuit is configured to independently control signals passed for different ones of the data streams by, for each data stream,
in response to sensing a main protocol signal on the pair of input pins for the data stream, control signals passed on the bus for the data stream using the main protocol, and
in the absence of sensed main protocol signals on the pair of input pins for the data stream, and in response to receiving an alternate protocol signal on the pair of input pins in accordance with one of the plurality of alternate protocols, control signals passed on the bus for the data stream in accordance with the alternate protocol signal and an input device operating with the alternate protocol.

16. A method for controlling communications on a bus circuit, the method comprising:
in a configurable protocol sense circuit, in response to receiving an alternate protocol signal on a set of input pins connected to the bus circuit, configure the bus for communicating data in accordance with a protocol for the alternate protocol signal; and
in an override sense circuit coupled to the input pins, in response to at least one of sensing a main protocol signal on the input pins and sensing a main protocol communication on the bus, override a configuration set via the configurable protocol sense circuit and configure the bus circuit for communicating data in accordance with the main protocol signal.

17. The method of claim 16, wherein configuring the bus for communicating data in accordance with a protocol for the alternate protocol signal includes setting data in a register that stores data used for controlling communications on the bus.

18. The method of claim 16, wherein configuring the bus for communicating data in accordance with a protocol for the alternate protocol signal includes, in response to receiving an alternate protocol signal on the input pins, configuring the bus for communicating data in accordance with a protocol for the alternate protocol signal by overriding the communications control in the bus set in a register.

19. The method of claim 16, wherein configuring the bus for communicating data in accordance with a protocol for the alternate protocol signal includes, in response to receiving an alternate protocol signal on the input pins, configuring the bus for communicating data in accordance with a protocol for the alternate protocol signal by overwriting data in a register with protocol data for the alternate protocol to control communications on the bus.

20. The method of claim 16, wherein
overriding a configuration set via the configurable protocol sense circuit and configuring the bus circuit for communicating data in accordance with the main protocol signal includes controlling the bus circuit to communicate using protocol data for the main protocol stored in a register, and
configuring the bus for communicating data in accordance with a protocol for the alternate protocol signal includes controlling the bus circuit to communicate using protocol data for the alternate protocol stored in a register.
